(19) United States
(12) Patent Application Publication
(10) Pub. No.: US 2002/0134297 A1
(43) Pub. Date: Sep. 26, 2002

(54) Anthem flag

(76) Inventor: Rashan Moye, Elyria, OH (US)

Correspondence Address: Richard C. Litman, LITMAN LAW OFFICES, LTD., P.O. Box 15035, Arlington, VA, 22215, US

(21) Appl. No.: 10/085,003

(22) Filed: Mar. 1, 2002

Related U.S. Application Data
(60) Provisional application No. 60/278,456, filed on Mar. 26, 2001.

(51) Int. Cl. G09F 17/00

(52) U.S. Cl. 116/173

(57) ABSTRACT

An anthem flag that plays the national anthem of the country that it represents. The anthem is made up of a representative flag banner, an elongated flagpole that holds the representative flag banner in an upright position and a touch activated miniature music box. The flag banner is attached to the elongated flagpole using a hook and loop fastener or glue inserted into a slit cut into the elongated flagpole. The national anthem of the country represents by the flag is activated by touching the activation button of the music box.

### CROSS-REFERENCE TO RELATED APPLICATION

This application claims the benefit of U.S. Provisional Patent Application Serial No. 60/278,456, filed Mar. 26, 2001.

### BACKGROUND OF THE INVENTION

1. Field of the Invention

The present invention relates to flags and flagpoles, and more specifically, to a flag with a pole or staff that contains a music box which plays the national anthem of the country represented by the flag.

2. Description of the Related Art

Flags are a powerful symbol of national pride that people feel for all over the world. Regardless of a person's nationality, people with flags are prominent at events such as the Olympics, World Cup soccer matches and other international sporting contests and events. Flags are also prominently reflected in the related art as are novelty devices that play music.

U.S. Pat. No. Des. 351,182 issued to Mage, describes the ornamental design of a music box that is in the shape of an American flag.

U.S. Pat. No. 4,554,856 issued to Esaki, describes a music box that is capable of simultaneously playing music and hoisting an indicator or flag up a pole which extends upright from a housing. The pole has a pulley that is mounted on a shaft interlocked with a rotating member having projections opposing a vibrating plate disposed within the housing. One end of a string is connected to a flag that is fixed to the pulley and is wound there around and the other end of the string is also fixed to the pulley through the to of the pole.

U.S. Pat. No. 4,628,791 issued to Phipps, describes a music box and a special clamp for securing the music box on an umbrella shaft at a location where a canopy-spreading mechanism of the umbrella automatically activates the music box when the umbrella is opened up.

U.S. Pat. No. 5,049,107 issued to De Nittis, describes a sound box that has a generally spherical container provided on its surface with graphic fields associated with respective contacts connected to a microprocessor within the container. A loudspeaker and circuitry are also provided which upon pressing of one of the fields generates a sound sequence representing the graphic depiction of that field.

U.S. Pat. No. 5,115,472 issued to Park et al., describes electroacoustical novelties having a piezoelectric polymer film which functions as a speaker or microphone. The novelties include flags, banners, posters and articles of headwear. The piezoelectric polymer film may be attached to a portion of the flexible substrate forming the novelty, or it may be used as an integral part of the novelty structure. An audio output or recording device is electrically coupled to the piezoelectric polymer film. Both the piezoelectric polymer film and the electrodes may be transparent so that the adjoining portion of the novelty is visible.

U.S. Pat. No. 5,692,328 issued to Pettit, describes an apparatus for displaying a flag, banner or pennant, so as to simulate waving in the wind and is particularly adapted for use with a novelty flag that is scaled for use in model railroad layouts. The apparatus employs a correspondingly scaled flag staff for coupling with and supporting the flag along one edge thereof. A drive arrangement is coupled to the flagstaff at the base thereof for producing a rotatory oscillating motion.

U.S. Pat. No. 6,297,438 issued to Por Paul, describes a toy for generating tone sequences including a sound-generating circuitry having multiple inputs, the activation of a particular input corresponding to a particular tone. The inputs are connected to a motion sensor whereby a particular motion of the toy is converted into a corresponding sound. The motion sensor may be a multiple position pendulum switch. Repeated motion of the toy in a plurality of directions allows a tone sequence to be generated. The circuitry may include a storage system to allow tone sequences to be retained for later playback.

Although each of the devices outlined in these patents outline a useful and novel device, what is really desired is a flag that can play the national anthem of the country that it represents while a person is holding or waving the flag. Such a device would be exciting for fans at international sporting events and political events held around the world.

None of the above inventions and patents, taken either singularly or in combination, is seen to describe the instant invention as claimed. Thus an anthem flag solving the aforementioned problems is desired.

### SUMMARY OF THE INVENTION

The invention is an anthem flag that plays the national anthem of the country that it represents. The invention is made up of a representative flag banner, an elongated flagpole that holds the representative flag banner in an upright position, and a touch activated miniature music box. The flag banner is attached to the elongated flagpole using a hook and loop fastener or glue inserted into a slit cut into the elongated flagpole. The national anthem of the country represented by the flag is activated by touching the activation button of the music box.

Accordingly, it is a principal object of the invention to provide a musical flag that can represent different countries throughout the world.

It is another object of the invention to allow a user to play his national anthem while the user's flag is being waved.

It is a further object of the invention to provide users with a flag that can better reflect or express their patriotism.

Still another object of the invention is to provide users with a unique way of expressing their patriotism.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a anthem flag according to the present invention.

FIG. 2 is a side perspective view of the first placement of a music box of an anthem flag according to the present invention.

FIG. 3 is a side perspective view of the second placement of a music box of an anthem flag according to the present invention.

FIG. 4 is a rear perspective view of a first attachment means of an anthem flag according to the present invention.

FIG. 5 is a side perspective view of a second attachment means of an anthem flag according to the present invention.

Similar reference characters denote corresponding features consistently throughout the attached drawings.

### DETAILED DESCRIPTION OF THE PREFERRED EMBODIMENTS

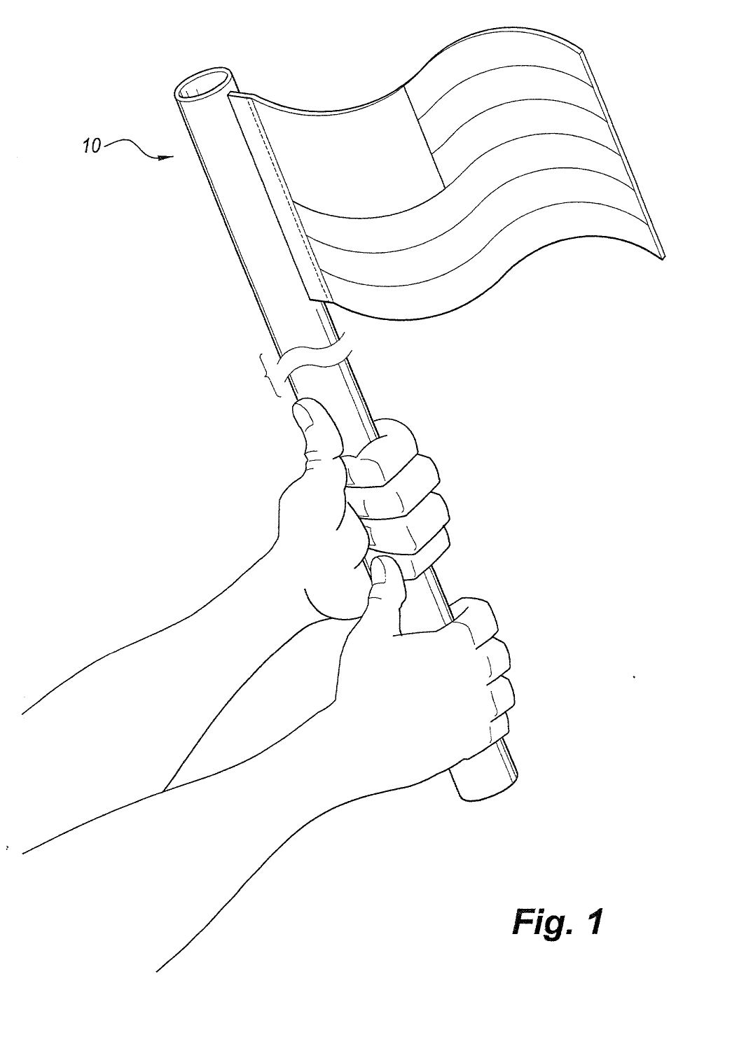

The present invention is an anthem flag 10 that plays the national anthem of the country that the anthem flag 10 represents. The anthem flag 10 comprises a representative flag banner 20, an elongated flagpole 30 that holds the representative flag banner 20 in an upright position, an attachment means for attaching the representative flag banner 20 to the elongated flagpole 30, and a touch activated miniature music box 40 that plays music, preferably the national anthem of the country represented on the flag banner 20. Note that the anthem flag 10 can also representant athletic teams (collegiate and professional) and can play the fight song of the represented team. An illustration of an environmental perspective view is provided in FIG. 1.

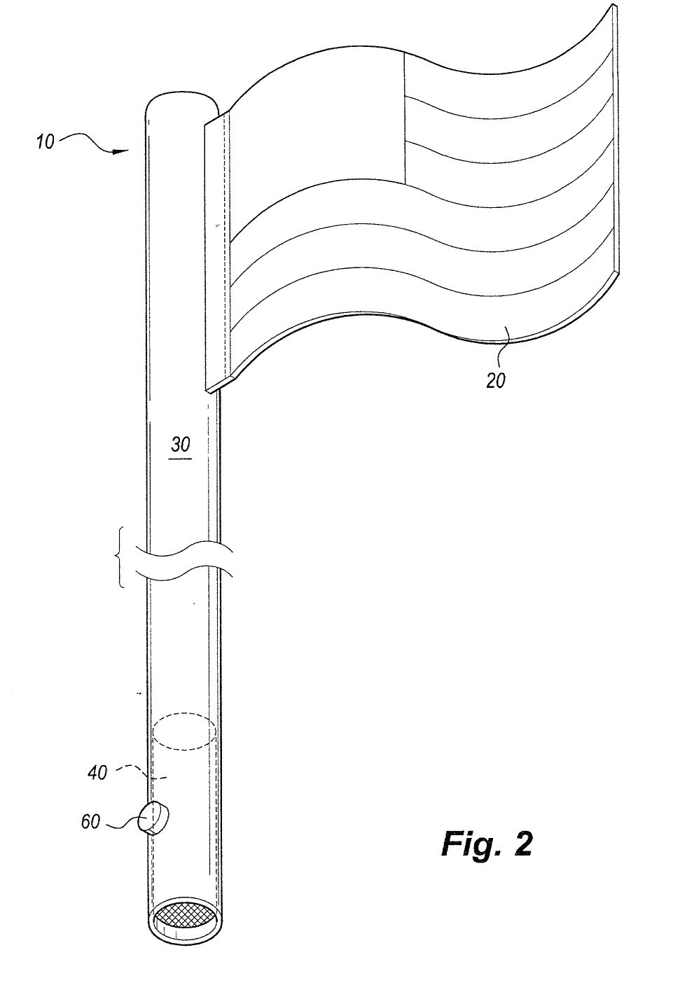

A side perspective view of the first embodiment of the anthem flag 10 is provided in FIG. 2. FIG. 2 depicts the flag banner 20 and elongated flagpole 30 used in combination with a miniature music box 40 that is embedded within the lower end of the elongated flagpole 30. An activation button 60 is exposed and can be physically touched to activate the miniature music box 40. Once activated, a person could touch the activation button 60 again to turn off the music box 40. The music box 40 is powered by a small thumbnail battery (not shown) which is well-known to those skilled in the related art.

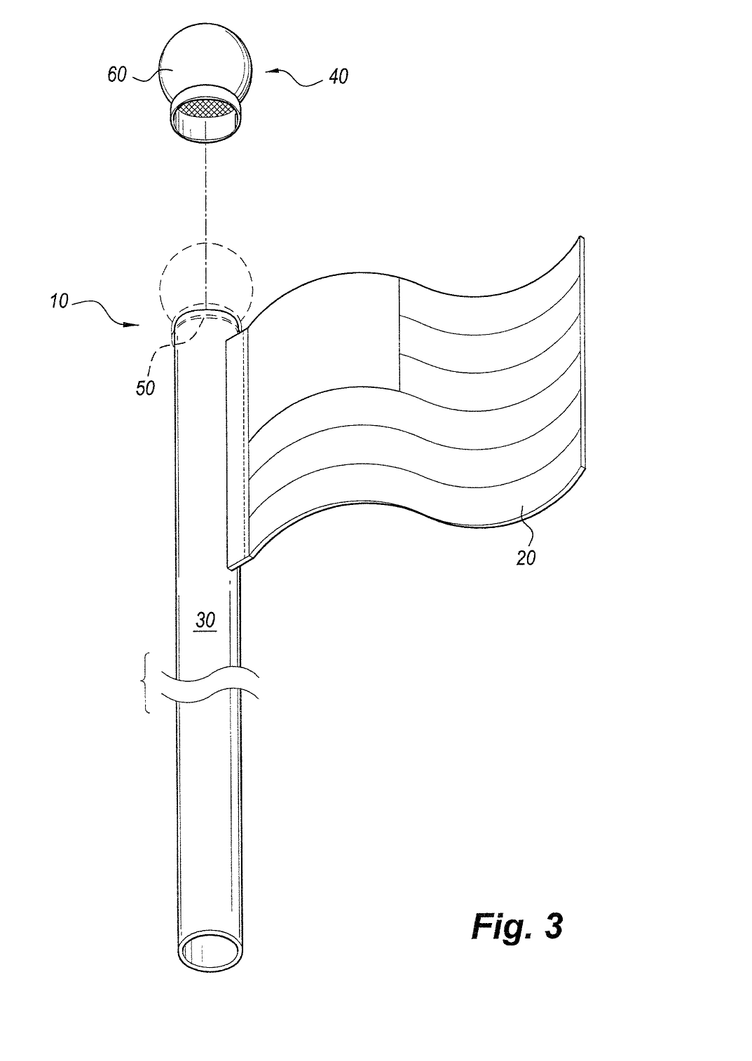

A side perspective view of the second embodiment of the anthem flag 10 is provided in FIG. 3. FIG. 3 depicts the flag banner 20 and elongated flagpole 30 used in combination with a miniature music box 40 that is snapped into place on the top of the elongated flagpole 30. A raised edge 50 is provided on the circumference of the top of the elongated flagpole 30 to allow the music box 40 to snap into place. In this embodiment of the anthem flagpole 10, music box 40 has an activation button 60 that is exposed to the outside of the elongated flagpole 30. The activation button 60 is the entire exposed bubble top that will activate the music box 40 upon a touch. Once activated, a person could touch the activation button 60 again to turn off the music box 40. The music box 40 is powered by a small thumbnail battery (not shown) which is well-known to those skilled in the related art.

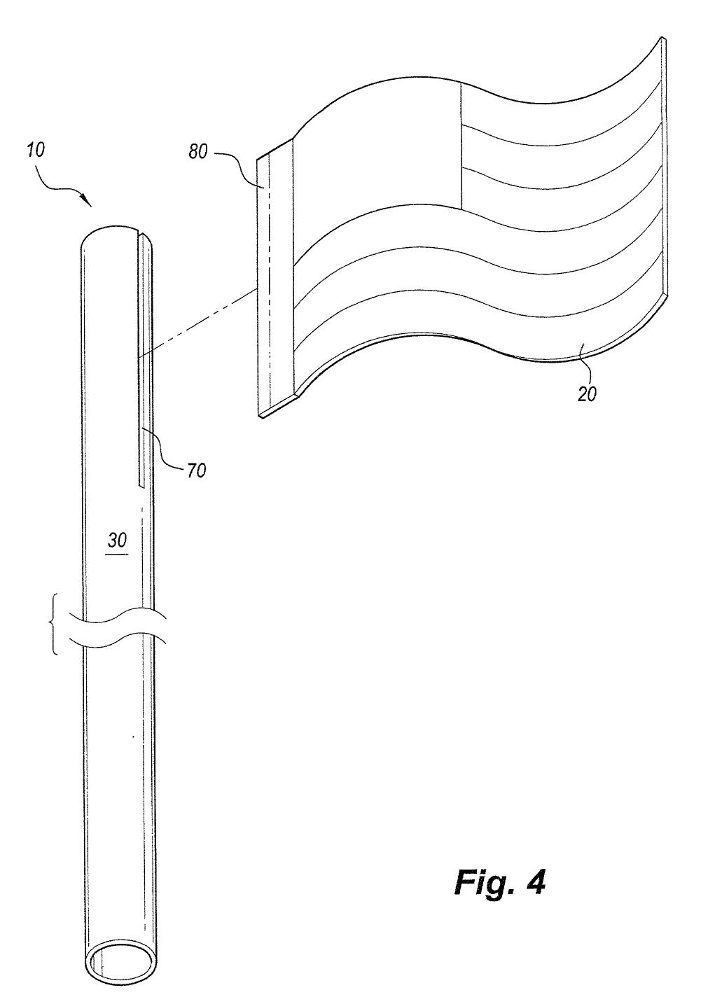

FIG. 4 illustrates the first attachment means for attaching the flag banner 20 to the elongated flagpole 30. The first attachment means is a slit 70 on the top outer surface of the elongated flagpole 30 that receives one end 80 of the representative flag banner 20 and is held within the slit 70 with glue (not shown). The elongated flagpole 30 is made of hollow plastic material and is a good backing for the glue.

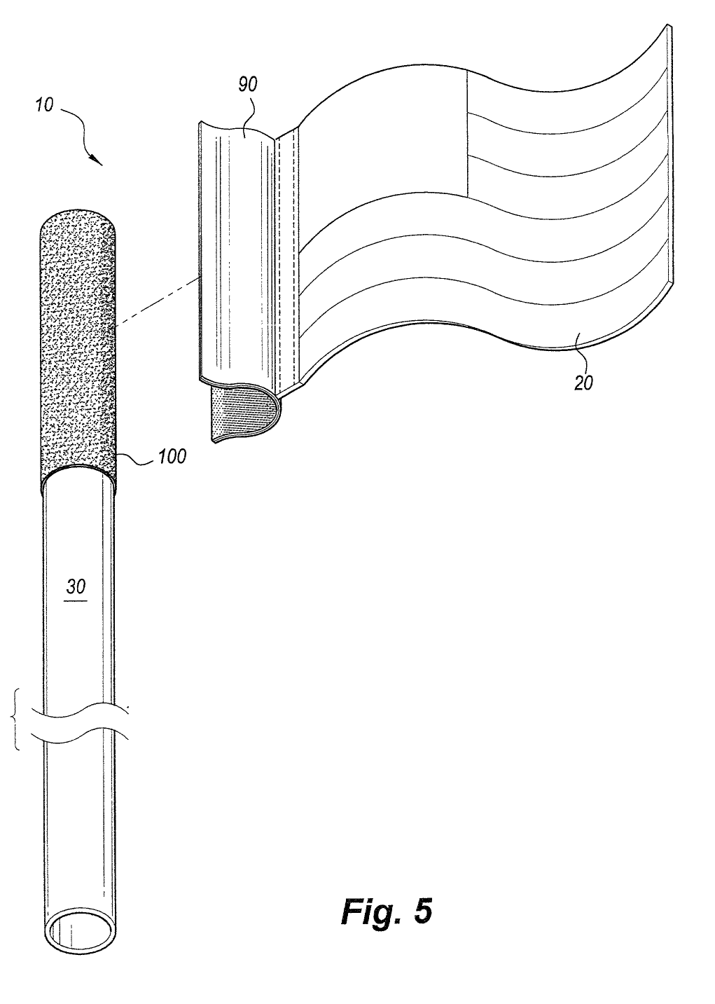

FIG. 5 illustrates the second attachment means for attaching the flag banner 20 to the elongated flagpole 30. The second attaching means is a sleeve 90 with a hook and loop fastener on the inside of the sleeve 90 and the outer surface of the elongated pole 100. The inside of the sleeve 90 can be wrapped around the top portion of the elongated pole 100 to form a hook and loop fastener between the flag banner 20 and the elongated flagpole 30. The flag banner 20 and the inside of the sleeve 90 can be easily pulled away from the top portion of the elongated flagpole 100 manually and can as be reattached as desired. As indicated earlier, the anthem flag 10 can be easily activated manually by touching the activation button 60 of either the first or second embodiments.

It is to be understood that the present invention is not limited to the embodiments described above, but encompasses any and all embodiments within the scope of the following claims.

I claim:

1. An anthem flag comprising:
a representative flag banner;
an elongated flagpole that holds the representative flag banner;
an attachment means for attaching the representative flag banner to the elongated flagpole; and
a touch activated miniature music box that plays music, associated with said flagpole.

2. The anthem flag according to claim 1, wherein said attachment means is a sleeve with a hook and loop fastener on the inside of the sleeve and the outer surface of the elongated pole.

3. The anthem flag according to claim 1, wherein said attachment means is a slit on the top outer surface of the elongated pole that receives one end of the representative flag banner and is held within the slit with glue.

4. The anthem flag according to claim 1, wherein said music box is embedded within the lower end of the elongated flagpole.

5. The anthem flag according to claim 4, wherein said music box has an activation button that is exposed to the outside of the elongated flagpole.

6. The anthem flag according to claim 1, wherein said music box is placed on the top of the elongated flagpole.

7. The anthem flag according to claim 1, wherein said music corresponds to the national anthem of the country that the flag banner represents.

8. The anthem flag according to claim 7, wherein said music corresponds to the fight song of the athletic team that the flag banner represents.

9. The anthem flag according to claim 1, wherein said elongated flagpole is made of hollow plastic material.
